(19) United States
(12) Patent Application Publication
(10) Pub. No.: US 2024/0116122 A1
(43) Pub. Date: Apr. 11, 2024

(54) A METHOD FOR OPTIMISING A MACHINING TIME OF A LASER MACHINING PROCESS, METHOD FOR CARRYING OUT A LASER MACHINING PROCESS ON A WORKPIECE, AND LASER MACHINING SYSTEM DESIGNED FOR CARRYING OUT THIS PROCESS

(71) Applicant: PRECITEC GMBH & CO. KG, Gaggenau (DE)

(72) Inventors: Tom Walde; Rüdiger Moser, Malsch (DE)

(21) Appl. No.: 18/276,698

(22) PCT Filed: Feb. 8, 2022
(86) PCT No.: PCT/EP2022/053004

§ 371 Date: Aug. 10, 2023

(30) Foreign Application Priority Data
Feb. 11, 2021 (DE) 10 2021 103 206.7

(51) Int. Cl. B23K 9/127

(52) U.S. Cl. CPC B23K 9/127

(57) ABSTRACT

A method for optimizing a machining time of a laser machining process includes: specifying a machining path of the laser machining process on the workpiece, said machining path having a plurality of machining path sections, specifying at least one boundary condition for at least one of the machining path sections; and determining control data for the laser machining process of the machining path taking into account the at least one boundary condition such that a machining time of the laser machining process is minimal. Furthermore, a method for performing a laser machining process on a workpiece includes such a method and a laser machining system is configured to perform the methods.

### CROSS-REFERENCE TO RELATED APPLICATIONS

This application is the U.S. National Stage of PCT/EP2022/053004 filed on Feb. 8, 2022, which claims priority to German Patent Application 102021103206.7 filed on Feb. 11, 2021, the entire content of both are incorporated herein by reference in their entirety.

### FIELD OF THE INVENTION

The present invention relates to a method for optimizing a machining time of a laser machining process, a method for performing a laser machining process on a workpiece, and a laser machining system configured to perform said methods.

### BACKGROUND OF THE INVENTION

In a laser machining system for performing a laser machining process on a workpiece, the laser beam emerging from a laser source or one end of a laser optical fiber is directed and focused onto the workpiece to be machines using beam guidance and focusing optics in order to locally heat the workpiece in a machining area up to the melting temperature. The laser machining process may comprise joining workpieces, for example laser welding or laser soldering, and separating workpieces, for example laser cutting. The laser machining system may comprise a laser machining device, for example a laser machining head, into which the beam guiding and focusing optics is integrated. The laser machining device also typically includes a deflection unit for deflecting the laser beam, for positioning the laser beam on the workpiece and for moving the laser beam on the workpiece along a machining path, and collimation optics for adjusting the focal position of the laser beam. Such laser machining devices are usually referred to as 2.5D or 3D laser scanners, or laser scanners or scanners for short.

The advantages of such laser machining systems are that they make it possible to position the laser beam very quickly and to move it on the workpiece. For this reason, these systems are now very often used in applications that require a large number of joining or separating spots at different positions on the workpiece.

It is one of the challenges in laser machining processes to develop for a given laser machining process, i.e. machining a workpiece using the laser beam along a given machining path, an optimal machining strategy which allows for the shortest possible and thus economical machining time. The machining strategy describes a machining sequence and/or a machining direction of sections of the machining path. Often, certain boundary conditions have to be taken into account when performing the laser machining process. For example, weldings of two adjacent machining path sections must be carried out with a specific time offset relative to one another, or weldings of specific machining path sections may only be carried out in a predetermined direction. Additional boundary conditions may include, for example, a specified welding speed or weld seam geometry for individual weld seams. The development of an optimal machining strategy becomes more difficult and complex when more machining path sections and/or boundary conditions for a machining path section have to be taken into account. A further increase in complexity results from the use of a plurality of laser machining devices in a laser machining system and in the case of 3D scanners with a third, typically slower scanner axis. In particular when developing new products, such as battery packs for electric cars, it frequently happens that the boundary conditions change. In this case, the machining strategy is often only adjusted locally, e.g. by changing the welding direction of a single machining path section, without checking whether a change in the global machining strategy would lead to a shorter machining time.

In addition, even with laser machining systems of the same type, machine parameters, such as delay times when ramping up the laser power via the laser source and speeds of deflection movements of the deflection unit, may differ within certain limits. These differences are usually not taken into account when optimizing the machining time.

Furthermore, while the laser machining process is being carried out, there is normally no longer any change to a machining strategy. As a result, current process data from the laser machining system cannot be used during the laser machining process to modify the machining strategy and thus to further minimize the machining time.

### SUMMARY OF THE INVENTION

It is an object of the present invention to provide a method for optimizing a machining time of a laser machining process for machining a workpiece using a laser beam, said method minimizing the machining time required for performing the laser machining process and thus increasing the economic efficiency of the laser machining process.

It is an object of the present invention to provide a method for optimizing a machining time of a laser machining process which can be carried out automatically or in an automated manner.

It is a further object of the present invention to provide a method for optimizing a machining time of a laser machining process, said method, taking into account individual machine parameters of a laser machining system and/or taking into account current process data, allowing for the machining time to be optimized, in particular while the laser machining process is being performed.

Furthermore, it is an object of the invention to provide a method for performing a laser machining process on a workpiece, said method comprising the method for optimizing the machining time, and a laser machining system configured to implement the method for optimizing the machining time and the method for performing a laser machining process.

One or more of these objects are achieved by the subject matter disclosed herein. Advantageous embodiments and developments are also disclosed.

The invention is based on the idea of taking into account the complete machining path of the laser machining process and all process-related boundary conditions of the laser machining process for optimizing, in particular minimizing, a machining time of a laser machining process on a workpiece and, based thereon, to determine automated control data for a laser machining system performing the laser machining process. As a result, it can be ensured that the laser machining process is always performed with an optimal or minimum machining time, in particular also in the case of changed or changing boundary conditions. Furthermore, the creation of a machining program for control software for the laser machining system is significantly simplified. In addition, the machining program can be adapted with minimal effort when individual boundary conditions change. The laser machining system includes at least one laser machining device, e.g. a laser machining head, in particular a laser welding or laser cutting head. In other words, the laser machining process may be performed by one laser machining device or by a plurality of laser machining devices.

According to a first aspect of the present invention, a method for optimizing a machining time of a laser machining process, also referred to below as an optimization method for short, is provided, said method comprising: specifying a machining path of the laser machining process on the workpiece, said machining path comprising a plurality of machining path sections, specifying at least one boundary condition for at least one of the machining path sections; and determining control data for the machining path of the laser machining process taking into account the at least one boundary condition such that a machining time of the laser machining process is minimal. To determine the control data, the optimization method according to the invention may comprise creating a target function for the machining time taking into account the specified boundary conditions and/or the specified machining path, and minimizing the target function. The target function may be minimized using an optimization algorithm in order to obtain optimized control data.

According to a second aspect of the present invention, a method for performing a laser machining process on a workpiece, also referred to below as laser machining method for short, is provided, said method comprising: performing the method for optimizing the machining time according to the first aspect of the present invention; and performing the laser machining process based on the control data.

According to a third aspect of the present invention, a laser machining system is provided, said laser machining system comprising: at least one laser source for generating a laser beam, and at least one laser machining device for radiating the laser beam onto a workpiece, wherein the laser machining device includes at least one deflection unit for deflecting the laser beam on the workpiece along a machining path, and wherein the laser machining system is configured to perform the optimization method and the laser machining method according to aspects of the present invention. In particular, the laser machining system may comprise a control device configured to control the laser machining system so as to perform the optimization method and/or the laser machining method according to aspects of the present invention.

The laser machining process may comprise laser joining, laser welding, laser cutting, in particular of thin foils, e.g. made of metal or plastic, laser inscribing, laser engraving, laser drilling, laser-based material removal, selective laser melting, or laser hardening. The laser machining process may comprise machining a workpiece by radiating a laser beam onto the workpiece along a predetermined machining path. The machining path may be defined as the entirety of the predefined points of incidence of the laser beam at which the workpiece is to be machined on the workpiece. The points of incidence of the laser beam may be defined, for example, based on predetermined positions of machining positions or areas on the workpiece for the laser machining process, for example as joints, separation points, welded and soldered seams, cut edges, drill and/or puncture holes, etc.

The machining path may include one or more machining path sections, also referred to as sections for short. A machining path section may be defined, for example, as an area of the machining path on the workpiece that is separated or spaced apart from other areas of the machining path. In other words, the machining path sections preferably do not overlap. A machining path section may be defined as a range of the machining path that extends linearly and/or is arranged at a predetermined angle, for example greater than 30°, to at least one adjacent machining path. Furthermore, the machining path section may be defined as a range of the machining path for which one or more boundary conditions for the laser machining process, for example a focal position, a laser power or a machining speed, are constant. A machining path section may, for example, have the form of a line, circle or point.

The machining time, also referred to as process time, may be defined as the time required to perform the laser machining along the machining path, in particular as the time from the start of laser machining to the end of laser machining. During the machining time, the laser beam may be radiated onto the workpiece along the specified machining path. Optimizing the machining time in the context of this invention means minimizing the machining time required to perform the laser machining process.

Aspects of the present invention may include one or more of the following optional features.

A plurality of (similar) laser machining devices, e.g. laser machining heads, in particular laser welding or laser cutting heads, may perform the laser machining on the workpiece. The laser machining devices may machine different areas of the machining path or different machining path sections, preferably simultaneously. For example, in the laser machining process, a first laser machining device may begin at a first end of the machining path or in a first area of the machining path and a second laser machining device may begin at a second end of the machining path or in a second area of the machining path. The different areas of the machining path or the different machining path sections may each be machined exclusively by one of the plurality of laser machining devices. The laser machining system may therefore include a plurality of (similar) laser machining devices, e.g. laser machining heads, in particular laser welding or laser cutting heads. Each of the laser machining devices may include a deflection unit for deflecting the laser beam on the workpiece, e.g. along a machining path (or along a part thereof) or along a machining path section.

In the case of a laser machining process by means of a laser machining system with a plurality of laser machining devices, all machining path sections in a first area of the machining path may be assigned to a first laser machining device, all machining path sections in a second area of the machining path may be assigned to a second laser machining device and (optionally) all machining path sections in a third area of the machining path may be assigned to a third laser machining device. In this case, the step of determining control data for each area of the machining path or for each laser machining device may be carried out separately or independently of one another and/or simultaneously or in parallel. In other words, the control data may be determined for and/or transmitted to each of the laser machining devices.

The control data can comprise a machining speed, a machining sequence and/or a machining direction of the machining path sections of the machining path to be machined. The machining sequence may indicate the order or sequence according to which each section of the machining path is machined during the laser machining process. In the case of a plurality of laser machining devices, individual sections of the machining path may be machine simultaneously or overlapping in time. The machining direction may indicate the direction along which the laser beam is radiated along a single section of the machining path. For linear or circular machine path sections, there are usually two possible directions.

The control data may include control commands in order to control the laser machining system performing the laser machining process or parts thereof, for example the laser source, the laser machining device(s), the (respective) deflection unit, and/or focusing and/or collimation optics of the at least one laser machining device for changing the focal position of the laser beam. The control data may further include specifications for a focal position of the laser beam, switch-on and/or switch-off times for the laser beam and/or a laser power, in particular for one or more machining path sections. The machining sequence determined by the method, the machining speed and/or the machining direction may be implemented by the laser machining system performing the laser machining process with the aid of the control commands. For example, by appropriately controlling the deflection unit, the laser beam can be moved on the workpiece in such a way that the specific machining sequence of the machining path sections is obtained or that a machining path section is machined in a specific direction.

The at least one boundary condition may specify a specification or a specified value, a minimum or maximum value, a range for a parameter and/or a profile for a parameter. The parameter may be a cooling time, a laser power, a machining speed, an energy input per unit length, a focal position of the laser beam, a distance between the laser machining device and the workpiece to be machined and/or a geometry of a weld seam, for example a width of the weld seam or a welding depth. For example, a boundary condition may include that a machining path portion must be machined with a specified minimum or maximum energy input per unit length. The energy input per unit length results, for example, from the laser power and the machining speed at which the laser beam is moved over the machining path section. In another example, a boundary condition may be that at least some or all machining path sections for which the same focal position is specified or the specified focal positions of which are within a Rayleigh length of the laser beam are machined in succession in order to reduce the number of adjustment processes of the focal position.

A specified value or range of a first parameter may be dependent on a specified value or range of a second parameter. When determining control data, a value of the parameter may be determined within the range specified by the boundary condition.

The at least one boundary condition may include at least one of the following boundary conditions for the at least one machining path section: a starting point and/or an end point for the laser machining process, a machining sequence of at least two of the machining path sections, a position of the machining path section, a waiting time for a machining path section to be machined or a cooling time for a machined machining path section, a cooling time for a weld seam or cut edge produced along one of the machining path sections, a machining direction, a laser power, a machining speed, an energy input per unit length, a joint type of two workpieces to be welded together, a workpiece material, a geometry of a weld seam, a focal position of a laser beam, and a distance of the laser machining device from the workpiece. For example, a boundary condition may include that a first machining path section must be machined after a second machining path section or that a machining path section must first cool down for a predetermined cooling time before a further machining section, in particular an adjacent machining section, may be machined.

The machining path and/or the at least one boundary condition may be entered via a user interface. For this purpose, the laser machining system may include a user interface, in particular a graphical user interface.

The at least one boundary condition may assign at least one machining path section to one of the plurality of laser machining devices of the laser machining system. In other words, at least one boundary condition may specify that a specific machining path section of the machining path is machined by a specific laser machining device of the laser machining system.

The at least one boundary condition may define a permissible range on the workpiece surface for the position of the at least one machining path section. When determining the control data, the position of the machining path section within the range may be adjusted in such a way that the machining time is minimized.

The control data for the laser machining process may be determined using an optimization algorithm, a linear optimization algorithm, a nonlinear optimization algorithm, a simplex algorithm, a traveling salesman algorithm, and/or a Newton-Raphson algorithm.

The method for optimizing a machining time of a laser machining process may further comprise: dividing a workpiece surface into a plurality of partial areas and dividing the machining path into a plurality of partial paths corresponding to the partial areas, and performing the steps separately for each of the plurality of partial paths. For example, the partial paths may be assigned to different laser machining devices of the laser machining system performing the laser machining.

The control data for minimizing the machining time may further be determined taking into account at least one machine parameter of the laser machining system performing the laser machining. The method for optimizing the machining time of a laser machining process according to embodiments of the present invention thus makes it possible to take individual machine parameters of an example of the laser machining system into account when determining the control data and minimizing the machining time. The machine parameters may be stored in the laser machining system and/or may be determined automatically by the laser machining system.

In an embodiment, the method may comprise determining at least one machine parameter of the laser machining system performing the laser machining or determining at least one machine parameter of the at least one laser machining device of the laser machining system performing the laser machining. For example, the control device may be provided with appropriate functionality for determining the machine parameters used for optimization. The at least one machine parameter may include delay times and/or response times of different components of the laser machining system.

For example, the at least one machine parameter may include one of: a delay time of a laser source, a delay time of a deflection unit of the at least one laser machining device, a delay time of a focusing and/or collimation optics of the at least one laser machining device, deviations between a target focus position and an actual focus position, and a Rayleigh length of the laser beam. The delay time of the laser source may describe, for example, the length of time of changing the laser power between actuating the laser source to generate a laser beam with a specified laser power and reaching the specified laser power. The delay time of the deflection unit may describe the length of time between actuating the deflection unit and reaching a predetermined position of the laser beam on the workpiece. The delay time of the focusing optics or the collimation optics may describe the length of time between actuating the optics and reaching the predetermined focal position of the laser beam.

For example, a respective delay time may be determined based on test or blind weldings on a workpiece with corresponding parameters specified differently. The delay times determined in this way may be taken into account when controlling the laser machining system or when determining the control commands for a minimized machining time. Optionally, the delay time(s) may be determined iteratively by renewed test or blind weldings so that accuracy can be increased.

The laser machining process may comprise joining workpieces, for example laser welding or laser soldering, and separating workpieces, for example laser cutting. The laser machining process may further comprise inscribing, removing material, laser melting, drilling, engraving and/or hardening workpieces. A laser machining process may further comprise a combination thereof. The workpieces may include metal, in particular steel, aluminum and copper, or plastic. The workpieces may be configured as foils or sheets. The workpieces may be part of a battery, for example tabs, or a fuel cell, for example bipolar plates.

The method for performing a laser machining process may further comprise acquiring process data during the laser machining process and adjusting the control data to minimize machining time based on the acquired process data.

The process data may be acquired for each of the laser machining devices. The process data may comprise data regarding at least one of the following parameters: a focal position of the at least one laser machining device, a deviation of an actual focal position from a target focal position for the at least one laser machining device, a machining depth of the at least one laser machining device, a weld pool geometry, a weld seam width, a welding depth, and a machining speed of the at least one laser machining device. The laser machining system and/or the at least one laser machining device may have corresponding sensors for determining these parameters. For example, the laser machining system and/or the at least one laser machining device may include a distance sensor, in particular a distance sensor based on OCT (optical coherence tomography), in order to determine a machining depth, in particular a welding or piercing depth. Furthermore, the laser machining system and/or the at least one laser machining device may include a sensor, in particular a photodiode and/or a camera, for determining a weld pool geometry and/or a weld seam width. The photodiode may be sensitive, for example, in the infrared wavelength spectrum.

According to a further aspect, a method for determining a delay time of at least one component of a laser machining system is provided, comprising: specifying a machining path and control data for the component for a laser machining process on a workpiece, said machining path comprising a plurality of machining path sections which differ in a value of the control data for the component; performing at least one test machining process along the specified machining path with the specified control data; and determining a delay time in adjusting the different values of the control data for the component based on the test machining process. The delay time may also be referred to as the response time. The component may comprise, for example, a device or component for moving the laser machining device and/or for moving the workpiece relative to the laser machining device, a deflection unit for deflecting the laser beam, a laser source, optics, in particular focusing and/or collimation optics, etc. The control data may comprise control commands to control the laser machining system performing the laser machining process or parts thereof, for example the laser source, the laser machining device, the deflection unit, and/or focusing and/or collimation optics for changing the focal position of the laser beam. The control data may include a machining speed, a machining sequence and/or a machining direction of the machining path sections of the machining path to be machined. The control data may further include specifications for a focal position of the laser beam, switch-on and/or switch-off times for the laser beam and/or a laser power. The machining sequence determined by the method, the machining speed and/or the machining direction may be implemented by the laser machining system performing the laser machining process with the aid of the control commands. For example, by appropriately controlling the deflection unit, the laser beam may be moved on the workpiece in such a way that the specific machining sequence of the machining path sections is obtained or that a machining path section is machined in a specific direction. The delay time may be, for example, a delay time of a laser source, a delay time of a deflection unit, a delay time of a focusing and/or collimation optics.

The laser machining process may comprise joining workpieces, for example laser welding or laser soldering, and separating workpieces, for example laser cutting. The laser machining process may further comprise inscribing, removing material, laser melting, drilling, engraving and/or hardening workpieces. A laser machining process may further comprise a combination thereof. The workpieces may include metal, in particular steel, aluminum and copper, or plastic. The workpieces may be configured as foils or sheets. The workpieces may be part of a battery, for example tabs, or parts of a fuel cell, for example bipolar plates.

### BRIEF DESCRIPTION OF THE DRAWINGS

Embodiments of the invention are described in detail below with reference to figures.

FIG. 1 shows a laser machining system for performing methods for optimizing a machining time of a laser machining process and methods for performing a laser machining process according to embodiments of the present invention;

FIGS. 2A to 2C illustrate a problem underlying the present invention and a solution according to the invention, and FIGS. 3A and 3B illustrate another problem underlying the present invention and a solution according to the invention;

FIG. 4 shows a flowchart illustrating a method for optimizing a machining time of a laser machining process according to embodiments of the present invention;

FIGS. 5A and 5B show flow charts illustrating a method for performing a laser machining process on a workpiece according to embodiments of the present invention;

FIG. 6 illustrates the division of a workpiece surface into a plurality of partial areas and the division of a machining path of a laser machining process into a plurality of partial paths according to embodiments of the present invention;

FIG. 7 illustrates the specification a range for a machining path portion of a laser machining process on a workpiece according to embodiments of the present invention;

FIG. 8 shows the photograph of a weld seam obtained by laser welding to illustrate a weld seam geometry; and

FIG. 9 shows a laser machining process by means of a laser machining system with a plurality of laser machining devices.

### DETAILED DESCRIPTION OF THE EMBODIMENTS

Unless otherwise noted, the same reference numbers are used below for identical elements and elements with the same effect.

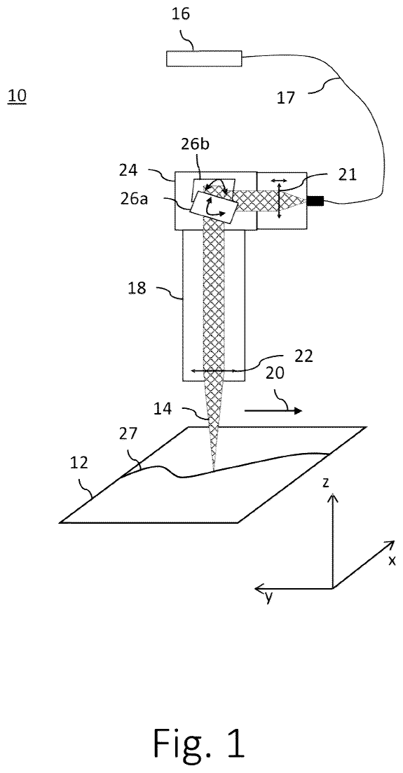

FIG. 1 shows a schematic diagram of a laser machining system according to embodiments of the present disclosure.

The laser machining system 10 is configured to machine a workpiece 12 using a laser beam 14. The laser machining system 10 comprises at least one laser source 16 for providing the laser beam 14, also referred to as a machining beam or machining laser beam, and at least one laser machining device 18 for radiating the laser beam 14 onto a machining area on the workpiece 12. The laser beam 14 may be coupled into the laser machining device 18 by means of an optical fiber 17. The laser machining device 18 may also be referred to as a laser machining head, laser head or head for short.

The laser machining system 10 or parts thereof, such as the laser machining device 18, may be movable along a feed direction 20 according to embodiments. The feed direction 20 may correspond to a machining direction, for example a welding direction or a cutting direction. In particular, the feed direction 20 may be a direction parallel to the surface of the workpiece 12.

The laser machining system 10 or the laser machining device 18 may include collimator optics 21, for example a collimator lens, for collimating the laser beam 14 and focusing optics 22, for example a focusing lens, for focusing the laser beam 14 on the workpiece. By directing and focusing the laser beam 14 onto the workpiece 12, the workpiece 12 is locally heated to melting temperature in a machining area. As a result, the workpiece 12 can be machined. Machining may comprise joining workpieces, for example laser welding or laser soldering, and separating workpieces, for example laser cutting. Machining may be part of a laser machining method or process. In other words, the laser machining system 10 may be configured to perform a laser machining method according to embodiments of the present invention.

According to typical embodiments, the collimator optics 21 and the focusing optics 22 are integrated into the laser machining device 18. The laser machining device 18 may include further elements that are not shown, for example a beam splitter or beam deflector, which may be configured as a partially transparent mirror in order to deflect the laser beam 14 by 90° in the direction of the workpiece 12.

The laser machining system 10 or the laser machining device 18 may comprise at least one optical element for the laser beam 14 which is configured to adjust the focal position of the laser beam 14. The at least one optical element may, for example, be displaceable along the optical axis in the diverging area of the laser beam 14 in order to change the focal position. In FIG. 1, the collimator optics 21 is shown as being displaceable along the optical axis. However, the invention is not limited thereto. According to further embodiments, alternatively or additionally, at least one optical element may be displaceable along the optical axis in the collimated area of the laser beam 14 in order to change the focal position. For example, the focusing optics 22 may be displaceable along the optical axis. The adjustment/displacement of the optical elements with respect to the optical axis for changing the focal position may be motorized, manual or a combination thereof. The focal position may be changed along the coordinate direction z shown in FIG. 1. The focal position of the laser beam 14 along the z direction may also be achieved by changing the position of the laser machining head along the z direction.

The laser machining system 10 or the laser machining device 18 may further include an optical measuring device (not shown), for example an optical coherence tomograph, for measuring a distance of the laser machining device 18 from the workpiece and/or for measuring a machining depth, for example a depth of the vapor capillary. The optical measuring device may be configured to direct an optical measuring beam onto the workpiece. The optical measuring beam and the laser beam 14 may be superimposed coaxially at least in portions. The optical measuring beam may be directed into the machining area. The principle of measuring the distance or the machining depth may be based on the principle of optical coherence tomography.

The laser machining system 10 or the laser machining device 18 may comprise an optical sensor including at least one photodiode. The sensor unit may be configured to detect process radiation, for example temperature radiation or IR radiation, UV radiation, light in the visible range, or back-reflected laser radiation emitted by the machining area. The sensor may can be used for process monitoring and provide process data.

The laser machining system 10 or the laser machining device 18 may further include at least one deflection unit 24 configured to deflect the laser beam 14 and thus change the position of the laser beam 14 on the workpiece 12, i.e. the point of incidence of the laser beam 14 or the machining area the workpiece 12. As a result, the laser beam 14 can be positioned on the workpiece 12 and moved on the workpiece 12. The deflection unit 24 may include at least one reflecting mirror which is rotatable about at least one axis. The mirror is preferably rotatable about two mutually perpendicular axes. The deflection unit 24 may include galvano mirrors, for example. According to the embodiment shown in FIG. 1, the deflection unit 24 include two movable mirrors 26a, 26b, which are rotatable about two axes, for example about two axes perpendicular to one another, in order to position and move the laser beam 14 as desired in one plane spanned by the drawn coordinate directions x and y (x-y plane). The coordinate directions x, y and z may form a Cartesian coordinate system.

Accordingly, the laser beam 14 may be moved by a deflection movement of the deflection unit 24 and/or by moving the laser machining device 18 along a traversing path on the workpiece 12. The speed at which the laser beam 14 is moved on the workpiece 12 along the traversing path may be referred to as the traversing speed. The laser beam 14 may be moved on the workpiece 12 on the basis of a machining path 27 specified by a laser machining process so that the specified machining path 27 is included in the traversing path of the laser beam 14 and the machining of the workpiece 12 can be performed along the machining path 27. The laser beam 14 may be switched on or off along the traversing path. When the laser beam 14 is switched off along the traversing path, the traversing path corresponds to the deflection movement of the deflection unit 24 or the movement of the laser machining device 18 which would result in this traversing path if the laser beam 14 were switched on. When the laser beam 14 is switched on, the traversing speed usually corresponds to the machining speed.

The deflection unit 24 may be configured as a scanner system or scanner optics. The deflection unit 24 or the laser machining device 18 may be referred to as a 2D scan system or 2D scan head. Combined with the change in focal position along the z coordinate axis, the laser machining device 18 may be referred to as a 2.5D or 3D laser scanner or 2.5D or 3D scan head.

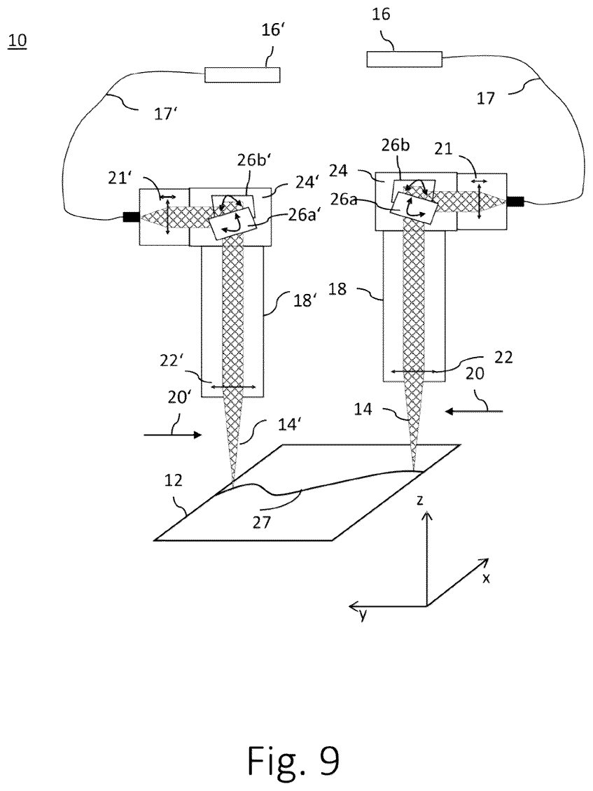

The laser machining system 10 may include more than one laser machining device 18, as shown for the number two in FIG. 9 by way of example. However, the present invention is not limited to two. In FIG. 9, each of the laser machining devices 18, 18′ is connected to its own laser source 16, 16′. Alternatively, a plurality or all of the laser machining devices 18, 18′ may be connected to the same laser source. The laser machining devices 18, 18′ may be constructed (largely) identically, but may be controlled separately by a control device of the laser machining system 10. A first of the laser machining devices 18, 18′ may perform the machining process at a first end of the machining path 27 or in a first area of the machining path 27 and a second of the laser machining devices 18, 18′ may perform the machining process at a second end of the machining path 27 or in a second area of the machining path 27. In other words, the laser machining devices 18, 18′ may machine different areas along the machining path 27 at the same time. This is of great importance, for example, for machining processes in the field of electromobility or in the manufacture of fuel cells. The present invention may be used, for example, in a laser machining system with two or more laser machining devices (also called laser machining heads or laser scanners) for welding bipolar plates in order to minimize machining time and thus increase productivity.

The present invention is described below based on the laser machining system 10 with a laser machining device 18 shown in FIG. 1. However, the present disclosure is not limited thereto and, as stated, may also be applied to laser machining systems 10 with a plurality of laser machining devices 18, 18′.

The laser machining system 10 may include further machine components, not shown, for moving the laser machining device 18 and/or for moving the workpiece 12 relative to the laser machining device 18. The laser machining system 10 may further include a control device configured to control elements of the laser machining system 10, for example the at least one laser machining device 18, 18′, the laser source 16, 16′, the deflection unit 24, 24′ or the machine components. For this purpose, the control device may transmit control commands to the elements of the laser machining system 10. In particular, the control device may be configured to perform the optimization method and the laser machining method in accordance with embodiments of the present invention.

The control device may adjust a pulse parameter and/or a laser power of the laser source 16, for example. In addition or as an alternative, the control device may adjust a focal position and/or a focal diameter of the laser beam 14, for example. Furthermore, the control device may output control commands for moving the collimator optics 21 and/or the focusing optics 22. In addition or as an alternative, the control device may be configured to change the position of the laser beam 14 on the workpiece 12. In particular, the control device may output control commands to the machine components for moving the laser machining device 18 and/or the deflection unit 24 of the laser machining device 18, for example for rotating the mirrors 26a, 26b.

The control device may include a user interface (also not shown) for interaction with a user. The control device may be configured to execute control software. The control software may execute a machining program stored in the control device, for example as a file. The machining program may include control commands for the laser machining system 10 or parts thereof for carrying out a specified laser machining process on the workpiece 12.

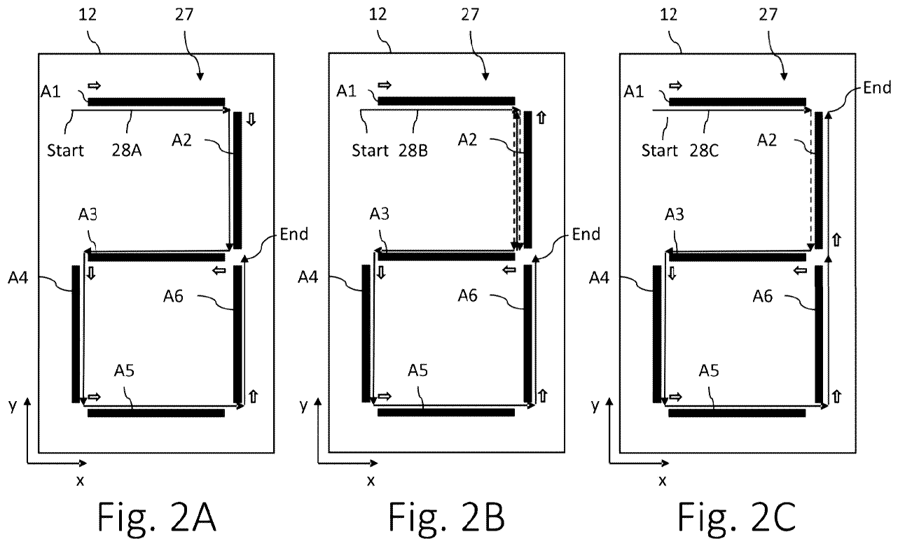

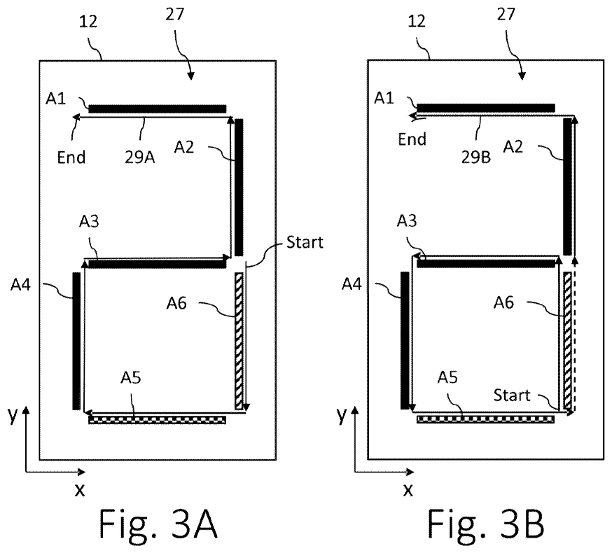

FIGS. 2A to 2C illustrate a problem on which the present invention is based and its solution according to the invention. In particular, FIGS. 2A and 2B illustrate how a machining time may be increased by changing a machining direction for a machining path section.

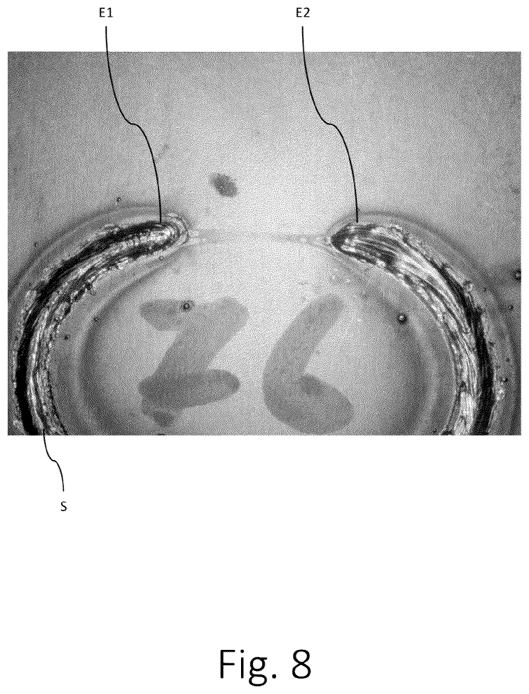

If welding is scheduled for a machining path section, then the machining or welding direction is of essential importance for the geometry of the resulting weld seam, as illustrated with reference to FIG. 8. FIG. 8 shows a photograph of a weld seam S. It is apparent that the geometry of one end E1 of the weld seam S differs significantly from the geometry of the other end E2. In this case, the end E1 corresponds to the start of the seam, i.e. the welding started there, and E2 corresponds to an end of the seam, i.e. the welding ended there. It is therefore essential in which direction a machining path section was welded. A similar situation applies to laser cutting.

A specified laser machining process includes, for example, machining a workpiece 12 by radiating a laser beam onto the workpiece 12 along a specified machining path 27 on the workpiece 12. FIGS. 2A to 2C illustrate the machining path 27 on the workpiece 12. The workpiece 12 lies in the x-y plane described above, but the invention is not limited thereto. The machining path 27 includes six machining path sections A1 to A6, which are illustrated using black bars. The machining path sections A1 to A6 run along the x or y direction, but the invention is not limited thereto. Machining may comprise, for example, laser welding to form a weld seam on the sections A1 to A6. The laser machining process may be performed using the laser machining system 10 described with reference to FIG. 1. For the following description, a constant traversing speed of the laser beam on the workpiece 12 and machining sections A1 to A6 of equal length are to be assumed.

A machining strategy for the specified laser machining process is to be determined such that the machining time for the laser machining process is minimal. Here, the machining strategy defines a machining sequence for sections A1 to A6 of the machining path 27 so that corresponding control commands for controlling the laser machining system 10, in particular the deflection unit 24 and the laser source 16, can be determined. The control commands may include, for example, a laser power, switch-on and switch-off times for the laser beam 14 and control commands for rotating the mirrors 26a, 26b for moving the laser beam on the workpiece 12 along the predetermined machining path 27. In FIGS. 2A to 2C, the traversing path 28A, 28B, 28C of the laser beam on the workpiece 12 is illustrated by means of solid and/or dashed arrows, respectively. Along the traversing path 28A, 28B, 28C, the laser beam may be on (solid arrows) or off (dashed arrows). The traversing path 28A, 28B, 28C next to the machining path 27 is shown in the figures solely for purposes of illustration.

In addition to the specified machining path 27, certain boundary conditions for the laser machining process are specified. First, the case illustrated in FIG. 2A will be described. As shown, a machining direction, in the present example a welding direction, is specified for each of the machining path sections 1 to 6 (illustrated by arrows filled with white in FIGS. 2A to 2C). In FIG. 2A, the machining direction of the machining section A2 is intended to be from top to bottom. Under these boundary conditions, a machining strategy results which is illustrated in FIG. 2A by the traversing path 28A of the laser beam on the workpiece 12, wherein the traversing path 28A may be implemented by appropriate control commands for the laser machining device 10.

In detail, the laser beam is radiated, in this sequence, from the start of the traversing path 28A onto the section A1 from left to right, i.e., along the x-direction, then onto the section A2, from top to bottom, i.e., opposite to the y-direction, onto section A3 from right to left, i.e. opposite to the x-direction, onto section A4 from top to bottom, onto section A5 from left to right, and finally onto section A6 from bottom to top, i.e. along the y-direction. With a constant traversing speed of the laser beam on the workpiece 12 and machining sections of the same length, the laser machining process thus lasts approximately 6 time units.

In current solutions for the control software for controlling the laser machining systems, the machining sequence and the machining direction are programmed without this programmed machining sequence and machining direction being optimized by the control software with regard to the machining time. Local changes are typically simply adopted, which may result in a longer machining time. The same applies to other laser machining processes, such as laser cutting. The machining time is therefore typically optimized manually, for example by a user, and not by software or an algorithm, for example the control software of the laser machining system. Conventionally, an automated optimization of the machining time by the control software is therefore not possible.

The case illustrated in FIG. 2B will now be described. Compared to the case illustrated in FIG. 2A, the machining direction of section 2 was changed as a boundary condition. Now, it is directed from bottom to top. FIG. 2B shows the case of a machining strategy that is only locally adapted compared to FIG. 2A. As in the case of FIG. 2A, the laser beam is first radiated along the traverse path 28B along the section A1 from left to right. Since section A2 must not be machined from top to bottom, but according to the changed boundary conditions from bottom to top, the laser beam is moved to the lower end of section A2 to start machining, with the laser beam being switched off during this time (dashed arrow downward). Section 2 is then machined by radiating the laser beam along section A2 from bottom to top (solid arrow upward). In order to be able to continue machining section 3 along the specified machining direction from right to left, the laser beam must again be moved to the lower end of section A2, during which time the laser beam is switched off (dashed arrow downward) in order to move the laser beam to the right end of the section A3 at the start of the machining. Between the section A3 and the section A6, the machining is carried out as in the case of FIG. 2A. Additionally traversing the switched off laser beam twice at section A2 results in an increased machining time of eight time units. Thus, compared to the case of FIG. 2A, the machining time was increased due to the changed boundary condition, i.e. due to the changed machining direction, and only local adaptation of the machining strategy.

FIG. 2C shows a case for the situation of FIG. 2B, but with a global change in machining strategy. The complete machining path of the laser machining process and all boundary conditions of the laser machining process are therefore taken into account in order to determine the traversing path 28C of the laser beam and corresponding control commands based thereon. As a result, after the section A1 has been machined by radiating the laser beam from left to right, the laser beam is moved to the lower end of section A2 or to the right end of section 3 (i.e. to the start of section 3), with the laser beam being switched off during this time is (dashed arrow). The laser beam is then switched on again and sections A3, A4, A5 and A6 are machined in this sequence and along the specified machining direction. Section A2 is therefore not machined for the time being. Only after section A6 has been machined, when the laser beam is at the upper end of section A6 and thus at the lower end of section A2, section A2 is machined from bottom to top. In the case of FIG. 2C, this results in a shorter machining time of only seven time units.

The example of the specified laser machining process illustrated with reference to FIGS. 2A to 2C thus shows that when there is a change in the boundary conditions, global optimization is advantageous over merely local change or optimization.

FIGS. 3A and 3B illustrate another problem underlying the present invention. FIGS. 3A and 3B illustrate in particular that determining the traversing path of the laser beam and corresponding control commands merely taking into account a predetermined machining direction of individual machining path sections is not always sufficient or does not always provide a working solution for a predetermined laser machining process.

FIGS. 3A and 3B illustrate the same machining path 27 for a given laser machining process as in FIGS. 2A to 2C. The traversing speed is again constant for the machining path 27 illustrated with reference to FIGS. 3A and 3B, however, in contrast to FIGS. 2A and 2C, no machining direction is specified for the individual sections A1 to A6 of the machining path 27. Instead, for process-related reasons, it is specified that section A6 must be welded first and that section A5 may only be welded after the weld seam of section A6 has cooled down for at least two time units.

In the case of pure path optimization, software or an algorithm could arrive at the result shown in FIG. 3A. As shown in FIG. 3A, the sections A6, A5, A4, A3, A2 and A1 are machined in this order according to the traversing path 29A shown in FIG. 3A. Eight time units are required in order to comply with the boundary condition of the cooling time of two time units.

With the aid of the method according to the invention for optimizing the machining time of the laser machining process, the optimal result of FIG. 3B can be obtained, wherein seven time units are required for the laser machining process and the boundary conditions for sections A5 and A6 described above are adhered to. As shown in FIG. 3B, the sections A6, A3, A4, A5, A2, A1 are machined in this order according to the traversing path 29B shown in FIG. 3B. As shown, traversing path 29B begins at the bottom of section A6 and section A6 is machined from bottom to top, then section A3 is machined from right to left, section A4 is machined from top to bottom, and section A5 is machined from left to right. At this time, the laser beam is again positioned adjacent to the lower end of section A6. The laser beam is then moved from there to the lower end of section A2 while the laser beam is switched off (dashed arrow). Once there, the laser beam is switched on again and section A2 is machined from bottom to top and then section A1 is machined from right to left. The laser machining process ends at the left end of section A1.

In addition to the problem that changes in the boundary conditions are often only taken into account locally without adapting the global or entire machining strategy for the machining path, there is also the fact that even machine parameters from laser machining systems of the same type may differ within certain limits. This can be caused, for example, by manufacturing tolerances in the manufacture of the laser machining system. Usually, no individual or specific machine parameters are taken into account when optimizing the machining time. Some machine parameters include parameters that are stored or saved in the laser machining system, for example as a standard value or average value, for example in the firmware. However, other machine parameters are not sufficiently known and must therefore be determined manually through tests and transferred to the control software. A (partly) automated determination of these machine parameters is not intended or not possible. These include, for example, delay times between the start of activation of the deflection unit and the laser reaching the specified position on the workpiece, the delay time of the focusing and/or collimation optics, deviations between a target focus position and an actual focus position, and delay times when switching on a laser beam and/or when ramping up the laser power by the laser source, which may be present in fiber lasers in particular. In addition, for conventional solutions for the control software for laser machining systems, current process data, which were acquired for process monitoring or process control, for example, cannot be taken into account inline, i.e. during the execution of a laser machining process.

The method for optimizing the machining time of a laser machining process according to embodiments of the present invention makes it possible to take machine parameters of the laser machining system into account and, optionally, to determine them automatically. Thus, with the aid of the method according to the invention, machine parameters that are sent directly from the laser machining system itself or components thereof or that are determined directly on the laser machining system itself can be taken into account. For example, the delay times between actuating the laser and reaching the position at which the welding is to take place using the laser may be determined automatically and/or data from the laser machining system may be taken from the corresponding firmware components. Such delay times, which are caused, for example, by switching the laser on/off or by a change in focal position, may be taken into account when determining control data for a minimum machining time, e.g. when determining a machining sequence. For example, for a 3D scanner system, it may make sense to first weld all sections of a machining path that are within a Rayleigh length of the laser beam and only then adjust the focal position of the laser beam in order to weld further sections.

The method for optimizing the machining time of a laser machining process according to embodiments of the present invention makes it possible to automatically develop, for each example of a laser machining system, an individual machining program for a given laser machining process for which the machining time is minimal. This also makes it easier to transfer a machining program from one laser machining system to another.

In addition, in the method for optimizing the machining time of a laser machining process according to embodiments of the present invention, currently acquired process data can be taken into account inline, i.e. while the laser machining process is being performed, when determining the control commands. The process data may originate, for example, from a sensor module for detecting process radiation or a distance sensor or the like.

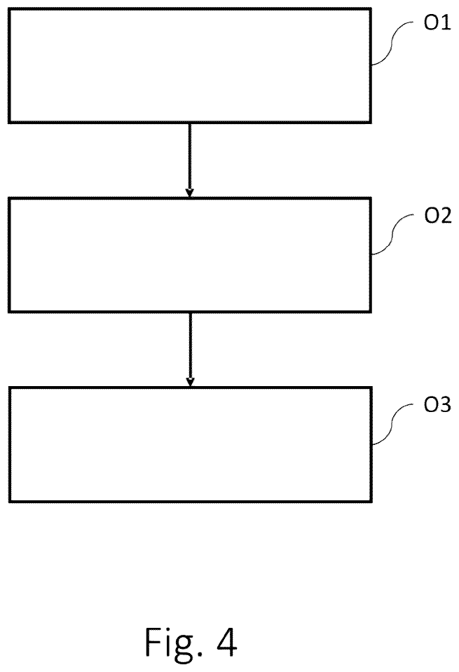

FIG. 4 shows a flowchart illustrating a method for optimizing a machining time of a laser machining process according to embodiments of the present invention.

The method includes specifying (01) a machining path of the laser machining process on the workpiece. The machining path includes a plurality of machining path sections. Then, at least one boundary condition is specified for at least one of the machining path sections (02). For the example shown in FIGS. 2A to 2C, the machining direction of the individual sections A1 to A6 of the machining path 27 is thus specified. The machining sequence for the individual machining path sections is variable, i.e. it does not represent a boundary condition in this example. For the example shown in FIGS. 3A and 3B, however, section A6 is used as the starting point in combination with a cooling time for section A6 or with a waiting time for section A5, namely 2 time units after the machining of section A6, while the direction of machining is variable. Furthermore, according to embodiments, further boundary conditions may be specified, for example a machining or welding speed, a geometry of the weld seam produced during laser welding, a laser power of the laser beam generated by the laser source, etc.

According to embodiments, the machining path with the machining path sections and the boundary conditions may be input by a user via a user interface, for example a user interface of the control unit for the laser machining system.

Subsequently, control data for the machining path of the laser machining process are determined (O3) taking into account the at least one boundary condition such that the machining time of the laser machining process is minimal. According to embodiments, the control data include a machining sequence and/or a machining direction of the machining path sections of the machining path to be machined. Furthermore, the control data may include control commands for the laser machining system or components thereof, for example the laser machining device, the deflection unit and/or the laser source, for performing the laser machining process.

The determination (O3) may be carried out automatically by the control device or control software. The method according to the invention therefore makes it possible that the user only has to specify or program the specified laser machining process including the machining path and the corresponding boundary conditions in the control device so that the necessary requirements are met from a functional or process-technical point of view. For example, in the example illustrated in FIG. 2, the user would define the machining speed, laser power, machining path (i.e., seam geometry), and machining directions for each machining path section. The control data are then automatically determined such that a machining time for the laser machining process is minimal and that the boundary conditions entered are met. For example, based on the boundary conditions explained with reference to the example in FIGS. 2A and 2C and the example in FIGS. 3A and 3B, the control device may automatically determine the corresponding control data including the machining sequence and machining direction explained in each case.

Furthermore, the method according to the invention makes it possible for the control data to be automatically redetermined when a boundary condition changes. For example, when changing the machining direction of a machining path section, the machining sequence may be checked automatically and, if necessary, the machining sequence may be changed. As explained with reference to the example of FIG. 2C in conjunction with FIG. 2A, the user could change the machining direction of section A2 via the user interface and the control device would determine the corresponding changed control commands for the laser machining system, as explained with reference to FIG. 2C.

According to embodiments, determining the control data for minimizing the machining time (O3) may also be performed taking into account at least one of the previously discussed machine parameters of the laser machining system performing the laser machining.

For example, the control device may be provided with appropriate functionality for determining the machine parameters used for optimization. The delay times may be determined using appropriate algorithms or routines. For example, blind weldings may be carried out on a workpiece with various specified parameters (e.g. the laser power or the welding speed) without taking into account the delay times of the laser machining system. The position, geometry and quality of the resulting weld seams may then be evaluated by an image processing system of the laser machining system and, if necessary, may be compared with specifications. For example, the number of pores in a weld or the width of a weld may be determined. Based thereon, the corresponding delay times may be determined and corrected by the control software. The delay times determined in this way may be taken into account when controlling the laser machining system or when determining the control commands for a minimized machining time. Optionally, blind weldings may be carried out again and the delay times determined may be checked with them. The control device may thus iteratively further increase the accuracy of the delay times.

Furthermore, by means of the optimization method according to embodiments of the present invention, there is the possibility of including further machine parameters in the optimization of the machining time. For this purpose, machine parameters stored or saved in the laser machining system, in particular in a firmware memory, may be read out by the control device. For example, traversing times, such as the traversing times of the collimation optics 20 described with reference to FIG. 1, may be taken from the firmware memory of the laser machining device 18.

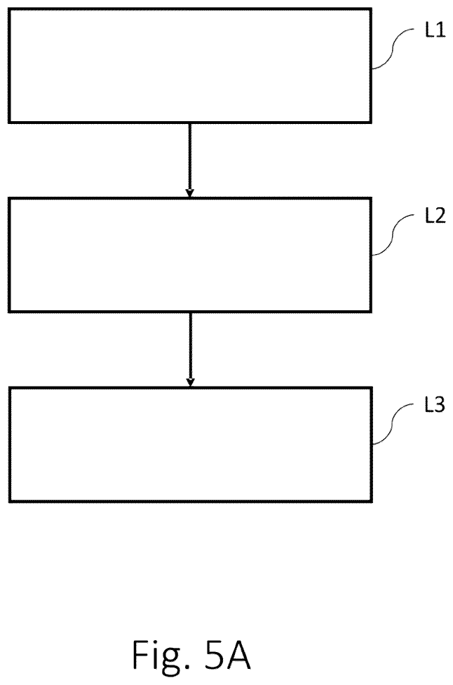

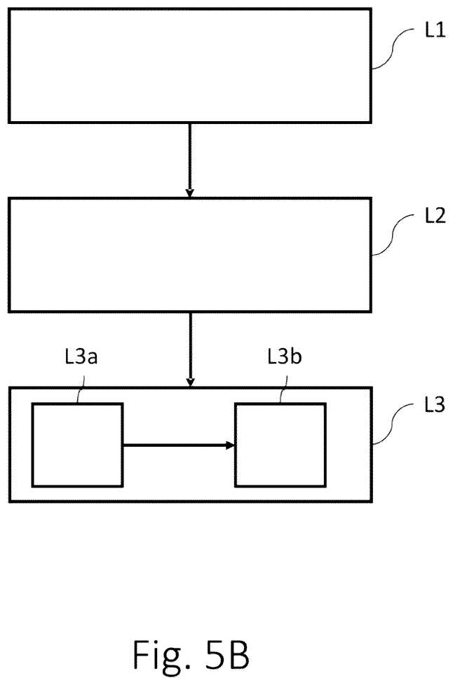

FIG. 5A shows a flowchart illustrating a method for performing a laser machining process on a workpiece according to an embodiment of the present invention.

The method for performing a laser machining process on a workpiece comprises the method for optimizing machining time according to embodiments of the present invention and performing the laser machining process based on the determined control data.

As shown in FIG. 5A, the method begins with the definition or change (L1) of parameters of the specified laser machining process, including specifying the machining path and specifying at least one boundary condition for at least one of the machining path sections, as in steps O1 and O2 described with reference to FIG. 4. Step L1 may be carried out by a user of the laser machining system that later carries out the laser machining. According to embodiments, specifying a boundary condition for a machining path section may include specifying a possible or permitted range for a parameter, for example for the laser power or the machining speed. A parameter for which a range is specified may also be referred to as a variable parameter. The variable parameter may be varied within the predetermined range in order to minimize the machining time in the step of optimizing the machining time and determining the corresponding control data described below.

Next (step L2), corresponding to step O3 described with reference to FIG. 4, the control data are determined. According to embodiments, step O3 or step L2 includes creating a target function for the machining time taking into account the boundary conditions specified by the user and minimizing the target function using suitable linear or possibly non-linear optimization algorithms (e.g. simplex, traveling salesman, Newton-Raphson, a variational approach, a heuristic approach). Determining the control data and minimizing the target function may include determining a constant or variable value for the variable parameters within the predetermined range. Furthermore, machine parameters of the laser machining system, which may be stored in a firmware memory or previously determined, for example, may be taken into account when optimizing the machining time and determining the control data. A machining program which is optimized for the respective laser machining system can thus be obtained.

Step O3 or step L2 may further comprise creating a machining program for the control software for performing the specified laser machining process later or subsequently. The machining program may, for example, be provided and saved as an executable file. The machining program may be executed by the control software to perform the laser machining process. The machining program may include the control commands of the control device for the components of the laser machining system that are required to carry out the laser machining process. The machining program may be transferred to other laser machining systems, for example by means of a suitable interface.

As the next step L3, the method includes performing the laser machining process by means of the laser machining system. Here, the machining program may be executed.

FIG. 5B shows a flowchart for illustrating a method for performing a laser machining process on a workpiece according to a further embodiment of the present invention. The method illustrated by FIG. 5B is similar to the method illustrated by FIG. 5A and therefore only the differences are described below.

The method for performing a laser machining process illustrated with reference to FIG. 5B includes acquiring process data (L3a) during the laser machining process, for example by means of a sensor unit. The process data may be current data and may include values for at least one of the following parameters: a focal position of the laser beam, a deviation of an actual focal position from a target focal position, a machining depth, a welding depth, a weld pool geometry, a weld seam width, and a machining speed. The process data may include the actual speeds of the scanner axes of the deflection unit, measured positions on the workpiece and information from the firmware. The method may further include adjusting the control data to minimize the machining time based on the collected process data (L3b). Adjusting the control data may be carried out during the laser machining process and repeatedly. Information from the laser machining system may thus be transferred to the control device during the laser machining process, which information may be used during the laser machining process, in particular during ongoing production, for automatic modification of the machining program.

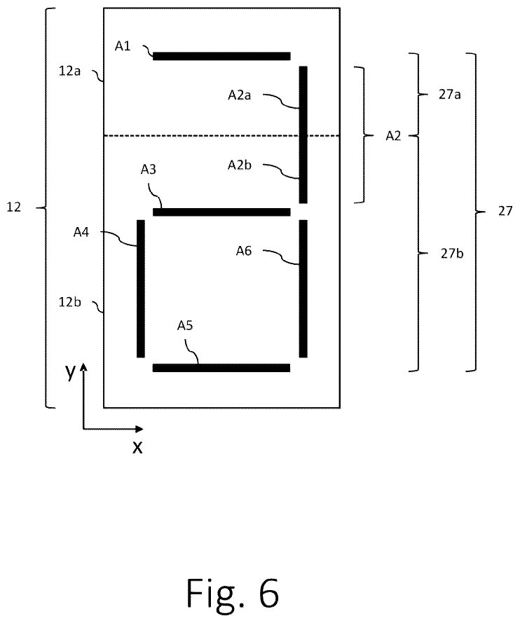

According to embodiments, the method for optimizing a machining time of a laser machining process further comprises dividing a workpiece surface into a plurality of partial areas, dividing the machining path into a plurality of partial paths, and performing the steps O1 to 03 described above with reference to FIG. 4 separately for each of the plurality of partial paths. As illustrated with reference to FIG. 6, the surface of the workpiece 12 has been divided into a first partial area 12a and a second partial area 12b. The division of the workpiece surface into the first and second partial areas 12a and 12b may be based, for example, on a condition or a topography of the workpiece surface. The machining path 27 for the specified laser machining process lies in both partial areas 12a and 12b and has been correspondingly divided into a first partial path 27a and a second partial path 27b. The machining path section A2 lies in both partial areas 12a and 12b and has been divided accordingly into partial sections A2a and A2b. Accordingly, the first partial path 27a includes the machining path section A1 and the partial section A2a of the machining path section A2 and the second partial path 27a includes the partial section A2b of the machining path section A2 and the machining path sections A3 to A6. According to embodiments, the surface of the workpiece may be divided into partial areas in such a way that the partial paths of the machining path contained in the partial areas have essentially the same length.

Dividing the workpiece surface into a plurality of partial areas and the machining path into a plurality of partial paths and determining control parameters may make the method for optimizing the machining time easier and faster to carry out since the optimization problem for optimizing the machining time for the entire workpiece surface is divided into smaller optimization problems for minimizing the process time for the respective partial areas. In particular in the case of a laser machining system 10 with a plurality of laser machining devices 18, 18′, the control parameters for each of the laser machining devices 18, 18′ or for areas of the machining path 27 which are assigned to different laser machining devices 18, 18′ for machining may be determined separately and/or simultaneously.

When the machining path, the machining path sections and/or the boundary conditions change in one of the partial areas of the workpiece surface, the optimization process only has to be carried out again for this partial area (or for this laser machining device), but not for the other partial areas as well. The time required to carry out the optimization method can thus be shortened and the computing time of the control device to carry out the optimization method can be reduced.

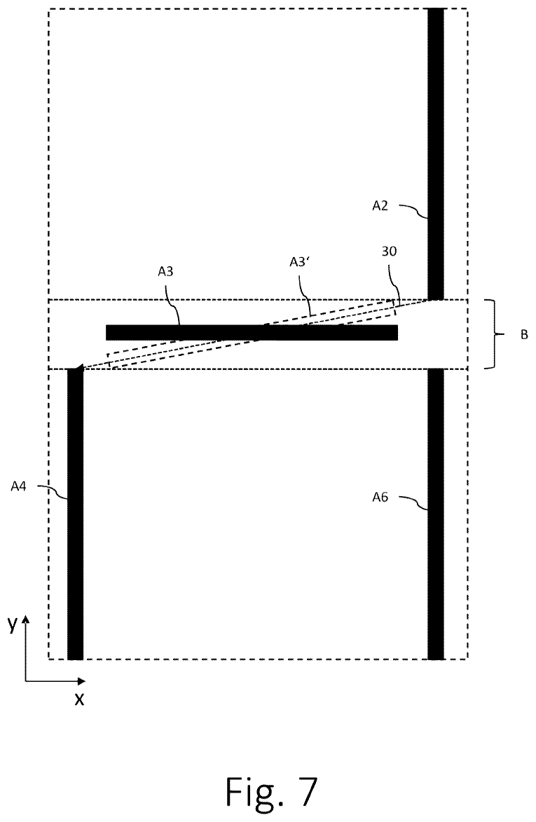

According to embodiments of the method for optimizing a machining time of a laser machining process, specifying a boundary condition for a machining path section of the machining path includes specifying an area or window for the machining path section on the workpiece. In this case, an attitude, position, orientation and/or shape of the machining path section may be modified when determining the control data such that the machining time is minimal. This is illustrated with reference to FIG. 7 for the machining path section A3. The machining path section A3 runs along the x-direction. However, for section A3, an area B is defined within which section A3 can be modified to optimize the machining time. As shown by way of example, the optimization method according to embodiments has determined the modified section A3′. The modified section A3′ is rotated counterclockwise from section A3. In this way, the traversing path 30 of the laser beam between the lower end of section A2 and the upper end of section A4 can be shortened and a shorter overall machining time can be achieved.

The method according to the invention for optimizing a machining time of a laser machining process on a workpiece relates determining control data for a laser machining system performing the laser machining process such that the machining time is minimal, wherein the entire machining path of the laser machining process and all process-technically relevant boundary conditions of the laser machining process can be taken into account. Furthermore, individual machine parameters of a laser machining system can be taken into account. This significantly simplifies the creation of machining programs for the control software of laser machining systems, in particular with laser scanners. In addition, the machining program can be adapted with minimal effort when individual boundary conditions change, wherein the influence on the machining time is automatically minimized. Furthermore, automatic optimization during series production, in particular during fuel cell production, is made possible.

1. A method for optimizing a machining time of a laser machining process, comprising:
specifying a machining path of the laser machining process on a workpiece, said machining path comprising a plurality of machining path sections;
specifying at least one boundary condition for at least one of the machining path sections; and
determining control data for said machining path of the laser machining process taking into account the at least one boundary condition such that the machining time of the laser machining process is minimal.

2. The method according to claim 1, wherein the control data include a machining sequence and/or a machining direction of the machining path sections of said machining path to be machined.

3. The method according to claim 1, wherein the control data comprises control commands for at least one deflection unit of a laser machining system performing the laser machining process and/or for a laser source of said laser machining system.

4. The method according to claim 1, wherein the at least one boundary condition comprises a specified value, a specified range and/or a specified curve for a parameter.

5. The method according to claim 4, wherein a specified value or range of a first parameter is dependent on a specified value or range of a second parameter.

6. The method according to claim 4, wherein, when determining control data, a value of the parameter is determined within the range specified by the boundary condition.

7. The method according to claim 1, wherein the at least one boundary condition for the at least one machining path section comprises at least one of the following boundary conditions: a starting point and/or an end point for the laser machining process and/or for at least one of the machining path sections, a machining sequence for at least two of the machining path sections, a position of the machining path section, a cooling time for a machined machining path section, a cooling time for a weld seam or cut edge produced along one of the machining path sections, a machining direction, a laser power, a machining speed, an energy input per unit length, a joint type of two workpieces to be welded together, a geometry of a weld seam, a focal position of a laser beam, and a distance of a laser machining device of said laser machining system from said workpiece.

8. The method according to claim 1, wherein the at least one boundary condition defines a range on the workpiece surface for the position of the at least one machining path section, and wherein, when determining the control data, an adjusted position of the machining path section is determined within the range so as to minimize the machining time.

9. The method according to claim 1, wherein determining control data for the laser machining process is performed using an optimization algorithm, a linear optimization algorithm, a non-linear optimization algorithm, a simplex algorithm, a traveling salesman algorithm, and/or a Newton-Raphson algorithm.

10. The method according to claim 1, further comprising:
dividing a surface of said workpiece into a plurality of partial areas and dividing said machining path into a plurality of partial paths corresponding to the partial areas; and
performing the steps separately for each of the plurality of partial paths.

11. The method according to claim 1, wherein said machining path and/or the at least one boundary condition is entered via a user interface.

12. The method according to claim 1, wherein determining the control data for minimizing the machining time is further performed taking into account at least one machine parameter of the laser machining system performing the laser machining, said at least one machine parameter comprising one of: a delay time of a laser source, a delay time of a deflection unit, and a Rayleigh length of the laser beam.

13. The method according to claim 1, further comprising:
determining at least one machine parameter of said laser machining system performing the laser machining process, said at least one machine parameter comprising one of: a delay time of a laser source, a delay time of a deflection unit, and a Rayleigh length of the laser beam.

14. A method for performing a laser machining process on a workpiece, comprising:
performing the method for optimizing the machining time according to claim 1;
performing the laser machining process based on the control data;
acquiring process data during the laser machining process; and
adjusting the control data to minimize the machining time based on the acquired process data.

15. The method according to claim 14, wherein the process data include data relating to at least one of the following parameters: a focal position, a deviation of an actual focal position from a target focal position, a machining depth, a welding depth, a weld pool geometry, a weld seam width, and a machining speed.

16. A laser machining system, comprising:
at least one laser source for generating a laser beam, and
at least one laser machining device for radiating the laser beam onto a workpiece, said laser machining device comprising at least one deflection unit for deflecting the laser beam on the workpiece along a machining path, wherein said laser machining system is configured to perform the method according to claim 1.
